(19) United States
(12) Patent Application Publication
(10) Pub. No.: US 2020/0089362 A1
(43) Pub. Date: Mar. 19, 2020

(54) DEVICE AND CONTROL METHOD CAPABLE OF TOUCH SENSING AND TOUCH PRESSURE SENSING

(71) Applicant: HiDeep Inc., Seongnam-si, Gyeonggi-do (KR)

(72) Inventors: Sung Ha CHOI, Seongnam-si, Gyeonggi-do (KR); Seyeob KIM, Anyang-si, Gyeonggi-do (KR)

(73) Assignee: HiDeep Inc., Seongnam-si, Gyeonggi-do (KR)

(21) Appl. No.: 16/610,022

(22) PCT Filed: May 4, 2018
(86) PCT No.: PCT/KR2018/005191

§ 371 Date: Oct. 31, 2019

(30) Foreign Application Priority Data
Jun. 20, 2017 (KR) 10-2017-0077985

(51) Int. Cl. G06F 3/041; G06F 3/0484; G06F 3/0488

(52) U.S. Cl. CPC G06F 3/0416; G06F 3/0484; G06F 3/0488; G06F 3/0412; G06F 3/0414

(57) ABSTRACT

A device according to the embodiment of the present invention includes a display; a touch sensing unit; a pressure sensing unit capable of sensing a magnitude of a pressure at the touched position; and a control unit. The control unit performs a control operation when a pressure touch is sensed and a swipe gesture in which a touch point is moved is sensed and then the swipe gesture ends. The control operation may be one of termination of running applications, changing into a one-hand keyboard mode, deletion or transmission of an object, and movement of the object. According to the embodiment of the present invention, the operability of the device is enhanced. According to the embodiment, it is possible to easily terminate running applications by using one finger even without using a separate home button.

### TECHNICAL FIELD

The present disclosure relates to a device capable of touch sensing and touch pressure sensing and a method for controlling the same, and more particularly to a device which is equipped with a touch sensing means and a touch pressure sensing means and is configured to improve user operability of the device by controlling the operation of the device in response to a pressure touch input, and a method for controlling the same.

### BACKGROUND ART

Various types of input devices are being used to operate a computing system such as smartphones, tablet PCs, laptop computers, navigation devices, KIOSKs, etc. A touch screen (a touch-sensitive display) among various types of input devices is being used increasingly in the computing system due to its easy and simple operability. Further, the laptop computer uses a touch panel, and thus, controls the screen displayed on the monitor or program execution. The use of this touch sensing means makes a user interface simple.

For example, an intuitive interface which uses a touch sensing means is used to enlarge or reduce images on the touch screen. That is, a zoom-in gesture for enlarging the image is generally performed by touching two touch points P1 and P2 on the screen through the use of two fingers (the beginning of the zoom-in gesture), by spreading the two fingers away from each other, and then by releasing the fingers from the screen. The device displays enlarged images in accordance with the zoom-in gesture. That is, from the beginning of the zoom-in gesture to when the finger spreads and stops, the device displays the images while increasing the degree of enlargement in accordance with how much the fingers spread.

However, since the two fingers must be used in the conventional zoom-in gesture, the user have to grip the device with one hand and perform the zoom-in gesture with two fingers of the other hand. Therefore, since both the hands must be used for the zoom-in gesture, when the user holds things with one hand or grips the handle of a subway, etc., it is difficult to perform the zoom-in gesture.

As such, a touch sensitive display which simply senses only the touch has a limit in enhancing user operability. In consideration of this, a device is being developed, which is capable of sensing not only a touch position but also a touch pressure, and many attempts are being made to improve the user operability in such a device. For example, Korean Laid-Open Patent Application No. 10-2015-0068957 discloses that, depending on the magnitude of the user's touch pressure, the zoom level for the geographic starting point and geographic destination is increased and the zoom level of other portions is reduced to reduce the time to load and render map images.

As such, attempts are being made to improve the device operability by using the touch pressure. However, a demand for various operation methods for controlling the device in response to the touch pressure is still not sufficiently satisfied.

### DISCLOSURE

### Technical Problem

A purpose of an embodiment of the present invention is to enhance the operability of a device capable of sensing a touch and touch pressure.

Another purpose of the embodiment of the present invention is to provide a user interface capable of easily terminating running applications even without using a separate home button in the device capable of sensing a touch and touch pressure.

Further another purpose of the embodiment of the present invention is to provide the user interface capable of easily changing to a one-hand input mode which allows a key input to be performed with one hand.

Yet another purpose of the embodiment of the present invention is to provide the user interface capable of easily performing object-related operations such as movement, rotation, transmission, deletion, and information display of the object, etc., with one hand.

Still another purpose of the embodiment of the present invention is to provide the user interface capable of conveniently controlling a default value of a control amount of the device.

### Technical Solution

One embodiment is a control method in a device capable of sensing a touch and touch pressure. The control device includes: a pressure touch sensing step of sensing a pressure touch; a swipe sensing step of sensing a swipe gesture in which the touch point is moved subsequent to the pressure touch; and a control operation step of performing a control operation when the swipe gesture ends.

Another embodiment is a control method including: a swipe sensing step of sensing a swipe gesture in which a touch point is moved from a first touch point to a second touch point; a pressure touch sensing step of sensing a pressure touch at a second touch point subsequent to the swipe gesture; and a control operation step of performing a control operation when the pressure touch is sensed.

Further another embodiment is a device including: a display; a touch sensing unit; a pressure sensing unit capable of sensing a magnitude of a pressure at the touched position; and a control unit. The control unit performs a control operation when a pressure touch is sensed and a swipe gesture in which a touch point is moved is sensed and then the swipe gesture ends.

Yet another embodiment is a device including: a display; a touch sensing unit; a pressure sensing unit capable of sensing a magnitude of a pressure at the touched position; and a control unit. The control unit performs the control operation when a pressure touch is sensed at a second touch point subsequent to a swipe gesture in which a touch point is moved from a first touch point to the second touch point.

The control operation may be one of termination of running applications, changing into a one-hand keyboard mode, deletion, transmission, movement, rotation of an object, information display of the object, and setting of a default value of a control amount such as screen brightness, sound volume, reproduction speed, zoom level, etc.

### Advantageous Effects

According to the embodiment of the present invention, since it is possible to easily terminate running applications by using one finger even without using a separate home button, it is convenient to use the device according to the embodiment of the present invention. Also, since it is not necessary to press the home button for the termination of the application, the home button can be removed according to the design of the device.

According to the embodiment of the present invention, it is possible to easily change with one hand to a one-hand keyboard mode which allows a key input to be performed with one hand.

According to the embodiment of the present invention, operations such as deletion, transmission, movement, rotation, and information display of the object, etc., can be easily performed with one hand.

According to the embodiment of the present invention, the setting of a default value of a control amount such as screen brightness, sound volume, reproduction speed, zoom level, etc., can be simply controlled with one hand.

### DESCRIPTION OF DRAWINGS

FIG. 1 is a functional block diagram of a device equipped with a touch screen according to an embodiment of the present invention;

FIG. 2 is a flowchart for describing the operation of the device according to a force and swipe gesture;

FIG. 3 is a view for describing up and down components and right and left components in a swipe direction;

FIG. 4 shows an example of determining whether the swipe direction is the up and down direction or right and left direction in accordance with absolute values of up and down components in the swipe direction and absolute values of right and left components in the swipe direction;

FIG. 5 shows an example of a two-hand keyboard;

FIG. 6 shows two examples of a one-hand keyboard;

FIG. 7 shows another example of the one-hand keyboard, in which key inputs are performed with right thumb;

FIG. 8 shows that after pressure touch is performed by a thumb of a hand gripping the device, an object “A” is deleted by performing a swipe gesture downward;

FIG. 9 shows that an application is touched with pressure and the position of the application is moved by performing the swipe gesture;

FIG. 10 shows that an object is touched with pressure and the orientation of the object is changed by performing the swipe gesture;

FIG. 11 is a flowchart for describing the operation of the device according to swipe and force gesture;

FIG. 12 shows that the swipe gesture is made from the application and is touched with pressure and the position of the application is moved;

FIG. 13 shows that the swipe gesture is made from the object and is touched with pressure and the orientation of the object is changed;

FIG. 14 shows that a value of a control amount is changed according to the swipe gesture which starts from at a position where a handle capable of changing the control amount is displayed, and the pressure touch is performed at a desired position and the value of the control amount corresponding to that position is set as a default value; and

FIG. 15 shows that information related to an object (book) is displayed according to the swipe, and control operations (purchase/rent) related to the object are performed according to the pressure touch on the object.

### MODE FOR INVENTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

Here, a device equipped with a touch screen and a method for controlling the same according to an exemplary embodiment of the present invention will be described with reference to the accompanying drawings. The device described in this specification may include a portable phone equipped with a touch screen, a smart phone, a laptop computer, a terminal for digital broadcast, a personal digital assistant (PDA), a navigator, a slate PC, a tablet PC, an ultrabook, wearable devices, KIOSK, etc.

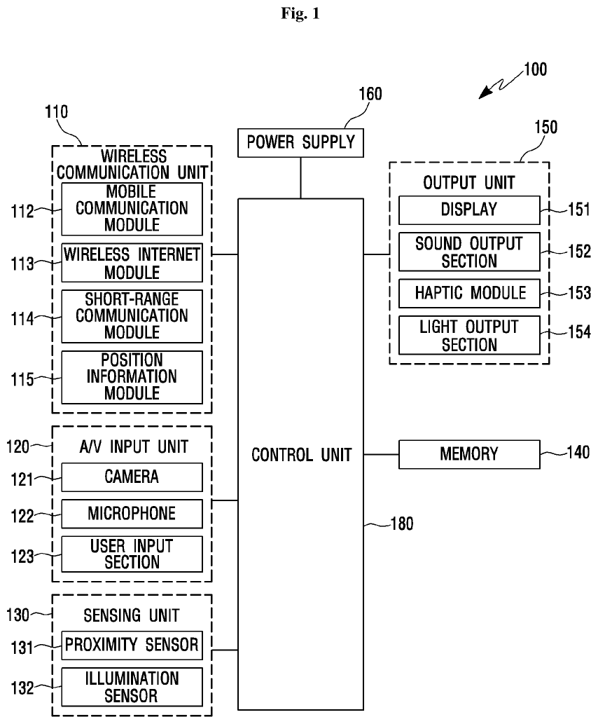

FIG. 1 is a block diagram of the device 100 of one embodiment to which the present invention can be applied, showing an example in which the present invention is applied to a smartphone.

The device 100 may include a wireless communication unit 110, an input unit 120, a sensing unit 130, an output unit 150, an interface 160, a memory 140, a control unit 180, and a power supply 160. The components shown in FIG. 1 are not indispensable in the implementation of the device. The device described in the present specification may have a larger or smaller number of the components than that of the components described above.

The wireless communication unit 110 may include at least one module enabling wireless communication between the device 100 and a wireless communication system, between the device 100 and another device 100, or between the device 100 and an external server. The wireless communication unit 110 may include at least one module which connects the device 100 to at least one network. The wireless communication unit 110 may include at least one of a mobile communication module 112, a wireless internet module 113, a short-range communication module 114, and a position information module 115.

The mobile communication module 112 transmits/receives a radio signal to and from at least one of a base station, an external terminal, and a server in a mobile communication network constructed in accordance with communication methods or technical standards for mobile communication. The wireless internet module 113 refers to a module for wireless internet access and may be built in or externally attached to the device 100.

The wireless internet module 113 transmits/receives a radio signal in a communication network based on wireless internet technologies such as Wireless LAN (WLAN), Wireless-Fidelity (Wi-Fi), etc.

The short-range communication module 114 supports short range communication by using Bluetooth™, Radio Frequency Identification (RFID), Infrared Data Association (IrDA), ZigBee, Near Field Communication (NFC), etc.

The position information module 115 obtains the position (or current position) of the device. A global positioning system (GPS) module or a wireless fidelity (Wi-Fi) module can be taken as a representative example of the position information module 115. However, the position information module 115 is not limited to a module for directly calculating or obtaining the position of the device.

The input unit 120 may include a video input section or a camera 121 for inputting a video signal, an audio input section or a microphone 122 for inputting an audio signal, and a user input section 123 (e.g., a touch key, a mechanical key, etc.) for receiving information of a user. The voice data or image data collected by the input unit 120 may be analyzed and processed as a control instruction of the user.

The camera 121 processes image frames of still images or videos, etc., obtained in a video call mode or in a photographing mode by an image sensor. The processed image frames may be displayed on a display 151 or may be stored in the memory 140.

The microphone 122 processes an external sound signal as an electrical voice data. The processed voice data can be variously used according to the function (or application program being executed) by the device 100.

The user input section 123 receives information from the user. When information is received through the user input section 123, the control unit 180 can control the operation of the device 100 in correspondence to the received information. The user input section 123 may include a mechanical input means (or a mechanical key, for example, a button disposed on the front, rear or side surface of the device 100, a dome switch, a jog wheel, a jog switch, etc.) and a touch-type input means. For example, the touch-type input means may include a virtual key, a soft key, or a visual key displayed on the touch screen through software processing, or may include a touch key disposed on a portion other than the touch screen. Meanwhile, the virtual key or the visual key can have various shapes and be displayed on the touch screen. For example, the virtual key or the visual key may consist of a graphic, a text, an icon, a video, or a combination thereof.

The sensing unit 130 may include at least one sensor for sensing at least one of information on the inside of the device, information on ambient environment surrounding the device, and user information. For example, the sensing unit 130 may include a proximity sensor 131, an illumination sensor 132, a touch sensor, an acceleration sensor, a magnetic sensor, a G-sensor, a gyroscope sensor, a motion sensor, etc.

The output unit 150 generates an output related to a visual sense, an auditory sense, or a tactile sense, etc. The output unit 150 may include at least one of the display 151, a sound output section 152, a haptic module 153, and a light output section 154.

The display 151 may include, for example, a liquid crystal display (LCD), a thin film transistor-liquid crystal display (TFT LCD), an organic light-emitting diode (OLED), a flexible display, a 3D display, an e-ink display, etc. The display 151 can implement the touch screen by forming a mutual layer structure with the touch sensor or by being integrally formed with the touch sensor. The touch screen can function as the user input section 123 providing an input interface between the device 100 and the user and can provide an output interface between the device 100 and the user as well.

In order that the display 151 can receive a control command in a touch manner, the display 151 may include the touch sensor which senses a touch on the display 151. Through this, when a touch occurs on the display 151, the touch sensor senses the touch and the control unit 180 may generate a control command corresponding to the touch on the basis of the touch. The content input in a touch manner may be characters or numbers, instructions in various modes, or a menu item that can be designated. Meanwhile, the touch sensor may be formed in the form of a film having a touch pattern and may be disposed between a window and the display 151 on the back side of the window, or may be composed of a metal wire directly patterned on the back side of the window. According to the embodiment of the present invention, a control unit sensing whether or not the touch occurs and the touch position on the basis of the signal sensed by the touch sensor may be provided in the display 151. In this case, the control unit transmits the sensed touch position to the control unit 180. Alternatively, the display 151 transmits the signal sensed by the touch sensor or a data obtained by converting the signal sensed by the touch sensor into a digital data to the control unit 180. The control unit 180 can determine whether or not the touch has occurred and the touch position.

The sound output section 152 outputs audio signals such as music, voice, etc., and may include a receiver, a speaker, a buzzer, and the like. The haptic module 153 generates various tactile effects that the user can feel. A typical example of the tactile effect generated by the haptic module 153 may be vibration. The light output section 154 outputs a signal notifying the occurrence of an event by using the light of the light source of the device 100. An example of the event that occurs in the device 100 may include message reception, call signal reception, missed call, alarm, schedule notification, email reception, information reception through an application, etc.

The memory 140 stores data supporting various functions of the device 100. The memory 140 may store a plurality of application programs (or applications) executed by the device 100, data for operation of the device 100, and commands At least some of these application programs may be downloaded from an external server via wireless communication. At least some of these application programs may exist in the device 100 from the time of release of the device 100 for the purpose of basic functions (e.g., call incoming and outgoing, message reception and transmission) of the device 100. Meanwhile, the application program is stored in the memory 140, installed in the device 100, and can be operated by the control unit 180 to perform the operation (or function) of the device.

The control unit 180 typically controls not only the operations related to the application programs, but also the overall operations of the device 100. The control unit 180 processes signals, data, information, etc., input or output through the above-described components, or executes the application programs stored in the memory 140, thereby providing appropriate information or functions to the user. In addition, the control unit 180 can control at least some of the components in order to execute the application programs stored in the memory 140. Further, the control unit 180 can operate the at least two components included in the device 100 in a combination thereof in order to execute the application programs.

The power supply 190 receives an electric power from external and internal power supplies under the control of the control unit 180, and supplies the electric power to each of the components included in the device 100. The power supply 190 may include a battery. The battery may be an embedded battery or a replaceable battery.

At least some of the respective components can operate in cooperation with each other in order to implement the operation, control or control method of the device according to various embodiments to be described below. Also, the operation, control or control method of the device can be implemented in the device by executing at least one application program stored in the memory 140.

Meanwhile, the foregoing has described the example in which the present invention is applied to a smartphone. However, when the present invention is applied to a device that is fixedly installed such as KIOSK, wired communication is applied instead of wireless communication and the camera, microphone, etc., can be changed and applied in such a manner as to be omitted. That is, the components may be appropriately added or omitted depending on the nature of the device to which the present invention is applied.

Further, although FIG. 1 shows that the touch sensor sensing the touch is included in the display 151, some or all embodiments of the present invention can be also applied to a device in which a separate touch panel is provided for sensing the touch and touch pressure, for example, a laptop computer, without including the touch sensor in the display 151. The following description Although the following description mainly describes operations in the device having the touch screen, the embodiments of the present invention can be applied in the same manner to the device having a separate touch panel.

The device 100 can distinguish the types of a touch command on the basis of a pressure. For example, the device 100 may recognize a touch gesture having a pressure less than and not equal to a predetermined pressure as a selection command for a touched area. Then, the device 100 can recognize a touch gesture having a pressure greater than a predetermined pressure as an additional command.

For this, the device 100 includes a pressure sensing unit for sensing the touch pressure. The pressure sensing unit may be integrally coupled to the touch screen or touch panel or may be provided as a separate component. The pressure sensing unit may be provided with a separate controller and may be configured to transmit the sensed pressure value to the controller or may be configured to simply transmit the sensed signal to the controller.

The pressure of the touch gesture can be detected by using various methods. For example, the displayer 151 of the device 100 may include a touch recognition layer capable of sensing a touch and a fingerprint recognition layer capable of sensing a fingerprint. When the user touches by varying the pressure, the image quality of the touched portion may vary. For example, when the user touches the displayer 151 slightly, the touched portion may be recognized as being blurred. On the contrary, when the user touches the displayer 151 by applying a force, the touched portion may be recognized as being clear and dark. Therefore, the displayer 151 including the fingerprint recognition layer can recognize the touched portion by means of the image quality proportional to the touch pressure. The device 100 may detect the intensity of the touched portion according to the image quality.

Alternatively, the strength of the touch pressure can be sensed using a touch area recognized by the device 100. When the user presses lightly the display 151, the area to be touched may be relatively small, and when the user presses strongly, the area to be touched is relatively large. The device 100 can calculate the touch pressure by using a relationship between the area to be touched and the pressure. Therefore, the device 100 can recognize a touch gesture having a pressure higher than a predetermined pressure.

The device 100 may also detect the pressure of the touch gesture by using a piezoelectric element. The piezoelectric element refers to a device which senses a pressure or causes deformation/vibration by using piezoelectric effect. When a particular solid material is subjected to mechanical stress (precisely, mechanical force or pressure) and a deformation occurs, polarization is generated within a certain solid and electric charge is accumulated (accumulate). When a particular solid material receives a mechanical stress (accurately, a mechanical force or pressure) and is deformed, polarization occurs within the solid material and electric charges are accumulated. The accumulated electric charges appear in the form of an electrical signal between both electrodes of the material, that is to say, voltage. This phenomenon is called piezoelectric effect, the solid material is called a piezoelectric material, and the accumulated charge is called piezoelectricity. The device 100 may include a sensing unit (not shown) including a layer made of the piezoelectric material, which can be driven by the piezoelectric effect. The sensing unit can detect applied mechanical energy (force or pressure) and electrical energy (voltage as a kind of an electrical signal) generated by the deformation due to the mechanical energy, and can sense the applied mechanical force or pressure based on the detected voltage.

In another embodiment, the device 100 may include at least three pressures sensors in the pressure sensing unit. The at least three pressures sensors may be arranged in different layers in the display area 151 or arranged in a bezel area. When the user touches the display 151, the pressure sensor can sense the magnitude of the applied pressure. The strength of the pressure sensed by the pressure sensor may be inversely proportional to a distance between the pressure sensor and the touch point of the display 151. The strength of the pressure sensed by the pressure sensor may be proportional to the touch pressure. The device 100 can calculate the touch point and the actual strength of the touch pressure by using the strength of the pressure sensed by each pressure sensor. Alternatively, the device 100 can detect the touch point by including a touch input layer sensing the touch input. The device 100 can also calculate the strength of the touch pressure of the touch point by using the detected touch point and the strength of the pressure sensed by each pressure sensor.

As such, the pressure sensing unit can be configured in various ways. The present invention is not limited to a specific pressure sensing method, and any method capable of directly or indirectly calculating the pressure of the touch point can be applied to the present invention.

Hereinafter, some embodiments of the present invention will be described in detail with reference to the drawings. In the following description, the “pressure touch” means a touch of a pressure greater than a critical pressure, and a “swipe gesture” refers to an operation of moving a touch point while a finger is in touch with the touch screen or the touch panel. According to the embodiment, the “swipe gesture” may be defined as the touch point moving in a state where the touch pressure is less than a predetermined pressure, or may be defined as the touch point moving regardless of the touch pressure. Meanwhile, according to the embodiment, it may also be determined that the swipe gesture is made only when the moving distance of the touch point after the pressure touch is greater than a predetermined distance. Alternatively, it is possible to configure to recognize only the swipe gesture made within a predetermined period of time as a valid swipe gesture.

In addition, in the following description, “subsequently” means that the next operation is continued while a finger is in touch with the touch screen or the touch panel. For example, an expression “a pressure touch is performed with one finger and subsequently the swipe gesture is made” means that after a touch of a pressure greater than a critical pressure is performed on the touch screen with one finger, the swipe gesture is made with the finger while maintaining the touch without releasing the finger.

The critical pressure may be appropriately set according to devices to which the present invention is applied, fields of application, etc. For example, the critical pressure may be set as a pressure having a fixed magnitude. The magnitude may be appropriately set according to hardware characteristics, software characteristics, etc. Further, the user is also allowed to set the critical pressure.

The swipe direction may be determined as a direction on the display screen, or may be determined based on the gravity direction in consideration of the tilt of the device measured by a tilt sensor.

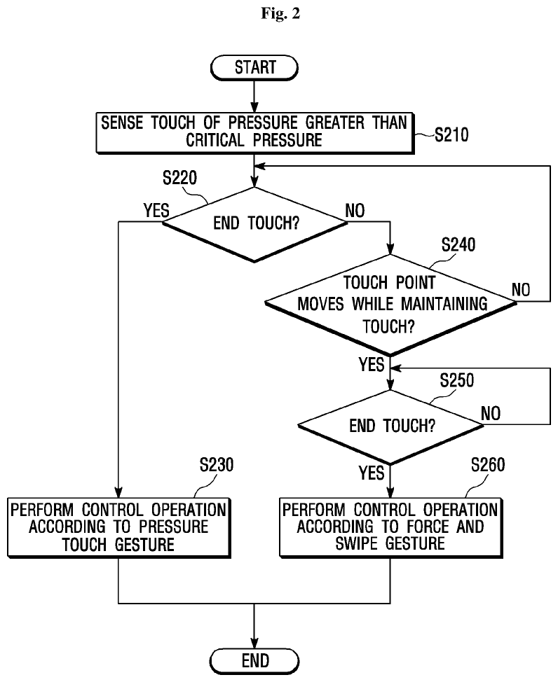

Next, one example of the operation of the device according to a force and swipe gesture will be described with reference to FIG. 2.

After the control unit 180 senses a touch of a pressure greater than a critical pressure (step S210) and when the touch ends (YES in step S220), the control unit 180 recognizes this as a pressure touch gesture and performs a predetermined control operation according to the pressure touch in step S230. The control operation according to the pressure touch gesture may be defined for each device and a detailed description thereof is omitted because this does not relate to the present invention.

Meanwhile, when the swipe gesture is sensed in which the touch point moves while maintaining the touch after the touch of a pressure greater than a critical pressure is sensed (YES in step S240), the control unit 180 determines whether the touch ends in step S250, that is to say, whether the finger which has touched is released from the touch screen. When the touch ends, the control unit 180 recognizes this as a force and swipe gesture and performs a predetermined control operation according to the force and swipe gesture in step S260.

Meanwhile, according to the embodiment, the predetermined control operation may be performed even while the swipe gesture is being made in step S240. For example, when the swipe gesture is made subsequent to the pressure touch performed on an object such as an icon or a game character, etc., the object can be displayed along the moving path of the swipe gesture.

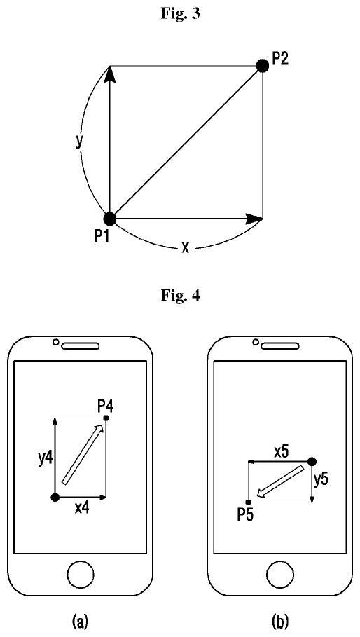

It is also possible to configure such that when the swipe gesture is sensed in step S240, the direction of the swipe gesture is determined together. The direction of the swipe gesture may be determined on the basis of the size of the up and down component and the size of the right and left component of an initial swipe direction. For example, if the swipe gesture is, as shown in FIG. 3, made from a touch point P1 to a touch point P2, it is possible to distinguish whether the direction of the swipe gesture is the up and down direction or right and left direction on the basis of the size of the up and down component y and the size of the right and left component x of the swipe direction.

For example, when the touch point moves, as shown in (a) of FIG. 4, to a touch point P4 after the pressure touch is performed, the absolute value of the up and down component y4 of the initial direction is larger than the absolute value of the right and left component x4 and the up and down component y4 has a positive value. Therefore, it is determined that the swipe gesture is in the upward direction. when the touch point moves, as shown in (b) of FIG. 4, to a touch point P5 after the pressure touch is performed, the absolute value of the right and left component x5 is larger than the absolute value of the up and down component y5 and the right and left component x5 has a negative value. Therefore, it is determined that the swipe gesture is in the left direction.

Alternatively, it is possible to configure to distinguish whether the direction of the swipe gesture is the up and down direction or the right and left direction on the basis of the size of the up and down component y and the size of the right and left component x of a vector between the pressure touch point and the swipe end point.

According to the embodiment, it may be configured to perform a specified control operation according to the direction of the swipe gesture. In addition, it is possible to configure to perform a specified control operation when the swipe direction and the time of the swipe gesture satisfy a predetermined condition. Alternatively, it may be configured to perform a specified control operation when the swipe direction and the swipe distance satisfy a predetermined condition. For example, it may be configured to perform an “A” control operation when swiping upward quickly after the pressure touch is performed, and to perform a “B” control operation different from the “A” control operation when swiping downward quickly after the pressure touch is performed.

Also, according to the embodiment, it may be configured to determine that it is a valid force and swipe gesture only when the swipe gesture is made after the pressure touch is additionally performed a predetermined number of times while the touch is maintained as it is after the pressure touch is performed. For example, after the touch is performed with a pressure greater than a critical pressure and the pressure is reduced below the critical pressure without releasing hand and then the touch is again performed with a pressure greater than the critical pressure, that is to say, only when the swipe gesture is made after the pressure touch is performed twice at the same position without releasing the hand, it may be determined that it is a valid force and swipe gesture.

Next, some embodiments of the control operation according to the force and swipe gesture will be described.

### FIRST EMBODIMENT

In the first embodiment, in a state where an application is being run in a foreground, when the user makes the force and swipe gesture and releases the finger, the running application is terminated. That is, in the state where the application is running, the control unit 180 senses the pressure touch at the first touch point, and then terminates the running application when the swipe gesture ends after the swipe gesture in which the touch point is moved is sensed.

According to the embodiment, it may be configured to terminate the application only when the force touch and/or the swipe gesture satisfy a predetermined condition. For example, it may be configured to perform the application termination operation when the direction of the swipe gesture satisfies a predetermined condition. For example, it may be configured to perform the application termination operation only when the swipe gesture is made downward after the pressure touch is performed.

According to the embodiment, it may be configured to perform the application termination when the direction of the swipe gesture is downward and the time of the swipe gesture is within a predetermined time. That is, it may be configured to terminate the running application when swiping downward quickly after the pressure touch is performed. Alternatively, it may be configured to terminate the running application when the direction of the swipe gesture is downward and the swipe distance satisfies a predetermined distance condition. For example, it may be configured to terminate the running application when swiping downward shorter than a predetermined distance after the pressure touch is performed. In addition, it may be configured to terminate the running application only when the swipe gesture is made after two pressure touches are performed at the same position without releasing the hand.

### SECOND EMBODIMENT

In the second embodiment, when the force and swipe gesture is made in a state where a keyboard is displayed on the screen, the keyboard is changed into a one-hand input keyboard. According to the embodiment, it is possible to configure to change the keyboard into the one-hand input keyboard only when the force and swipe gesture is made on the keyboard.

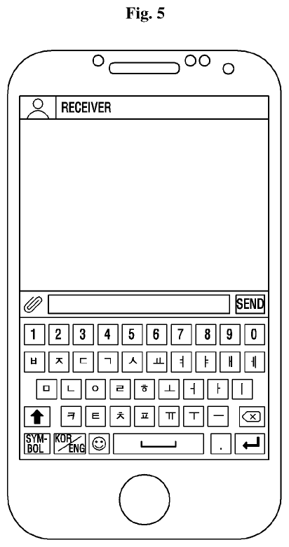

When character input such as inputting phone number, writing text messages, entering a search term in a web browser, etc., or writing an email, etc., is required, a keyboard is, as shown in FIG. 5, displayed across the entire right and left widths of the screen (hereinafter, referred to as “a typical keyboard”) and the user touches a desired key of the keyboard to input characters. In the case of a smartphone, it is common that a character is input by using two thumbs while holding the device with two hands, or a character is input by using an index finger of one hand while holding the device with the other hand.

However, when two hands cannot be used for character input, such as when holding a bag with one hand or holding a bus handle with one hand, the user must hold the device with one hand and input characters with the thumb of the same hand. In this case, in a typical keyboard displayed across the entire right and left widths of the screen, it is difficult to touch a key displayed at the end of the keyboard with the thumb of a hand holding one side of the device. The larger the smartphone is, the more problematic it is.

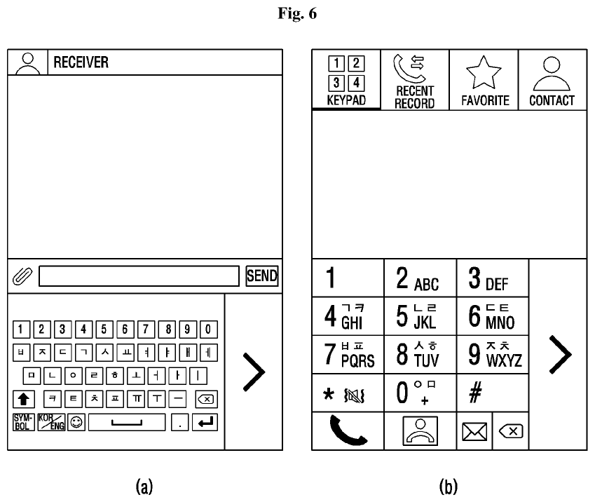

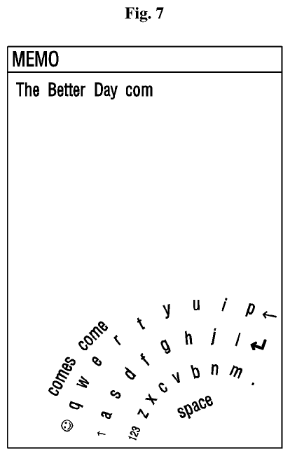

In order to solve this problem, a one-hand keyboard shown in FIG. 6 or 7 is used. However, it is inconvenient to perform an operation for switching to a one-hand keyboard mode with one finger as necessary. In this embodiment, in order to overcome this problem, in the state where the typical keyboard is, as shown in FIG. 5, displayed, the keyboard is changed into the one-hand input keyboard by the force and swipe gesture. The force and swipe gesture can be made by the thumb of the hand holding the device. Therefore, even when a character or a phone number needs to be input only by one hand, a character can be input by changing the keyboard into the one-hand keyboard.

Meanwhile, the one-hand keyboard is generally pushed to any one of the right and left sides. According to the embodiment, the arrangement direction of the one-hand keyboard may be determined based on the swipe direction of the force and swipe gesture. For example, when the swiping is done to the left, the keyboard is, as shown in FIG. 6, displayed to be pushed to the left. Alternatively, it is often more convenient to swipe the thumb in the opposite direction to a direction of the back of the hand than to swipe the thumb toward the back of the hand, so that the keyboard can be displayed on the opposite side to the swipe direction. For example, when the device is held by the left hand, the keyboard arranged on the left side is convenient. In this case, swiping the thumb to the right may be more convenient than swiping to the left. For such a user, when the swiping is done to the right, the keyboard may be, as shown in FIG. 6, configured to be displayed to be pushed to the left. In order to return from the one-hand keyboard mode of FIG. 6 to a typical keyboard mode, the force and swipe gesture is made on the keyboard again, or a bracket portion (>) shown in FIG. 6 is touched.

In addition, according to the embodiment, the arrangement direction of the one-hand keyboard may be determined based on the position of the pressure touch. For example, when the pressure touch is performed on the left side from the center of the keyboard, that is, when the position of the pressure touch is left, the one-hand keyboard is displayed to be pushed to the left, and when the position of the pressure touch is right, the one-hand keyboard is displayed to be pushed to the right. In this case, the swipe direction after the pressure touch does not affect the arrangement direction of the one-hand keyboard.

Meanwhile, FIG. 6 shows that a keyboard that has the same form as that of a typical keyboard and is displayed to be pushed to any one side is used as the one-hand keyboard. However, the form of the one-hand keyboard is not limited to a specific form. For example, the keyboard may be configured to have a semicircular form or a quarter circle form shown in FIG. 7 such that it is convenient to input with the thumb of one hand. FIG. 7 shows an example of the one-hand keyboard in a case where key input is performed by the thumb of the right hand.

### THIRD EMBODIMENT

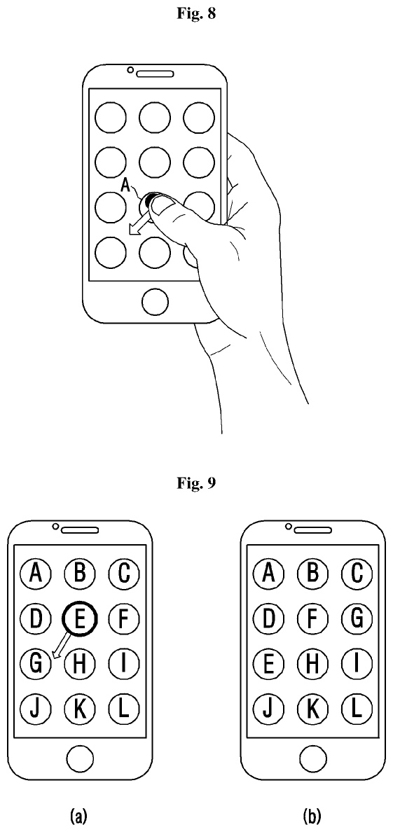

In the third embodiment, when the force and swipe gesture is made on an object, a file control operation is performed such as deleting the object, transmitting the object to another place, for example, a recycle bin, or forwarding the object to the outside. There may be various objects such as a text message, an email, a document file, a music file, a video file, an application, a friend list, and the like. When the list of the objects is displayed on the screen, the user makes the swipe gesture after applying the pressure touch to the object to be manipulated. According to the embodiment, an operation to be performed can be designated based on the swipe direction. For example, when the swipe gesture is made downward, the corresponding object may be deleted, and when the swipe gesture is made upward, the operation to transmit to another place may be performed. FIG. 8 is a view showing that an object A is deleted by making the swipe gesture downward after the pressure touch is applied by the thumb of a hand holding the device. The transmitting operation to another place may be, for example, transmit to another application, transmit to another device, transmit to (copy in) a temporary storage space, transmit to (stores in) another storage space (contacts, photo album, and the like), etc. In addition, when there are a plurality of transfer destinations, the force and swipe gesture is made, so that a list of transfer destinations (other applications, other devices, storage spaces, etc.) is displayed and one of them is selected.

### FOURTH EMBODIMENT

According to the fourth embodiment, when the force and swipe gesture is performed on the object displayed on the screen, the position of the object is changed according to the swipe gesture. There may be a variety of objects such as a file on a file list, a character in a game, an application on an application list, a friend on a friend list, or a digital note. When the object is displayed on the screen, the user applies the pressure touch on the object to be manipulated and makes the swipe gesture, and then releases his/her hand at a destination to which the object is intended to be moved. The object is then moved and placed from its original position to the end point of the swipe gesture. FIG. 9 shows an example in which the pressure touch is applied to an application E and the swipe gesture is made on application E as shown in (a) and then the position of the application E is, as shown in (b), moved. Meanwhile, it is also possible to configure to display the object along the moving path of the swipe gesture while the swipe gesture is being made.

### FIFTH EMBODIMENT

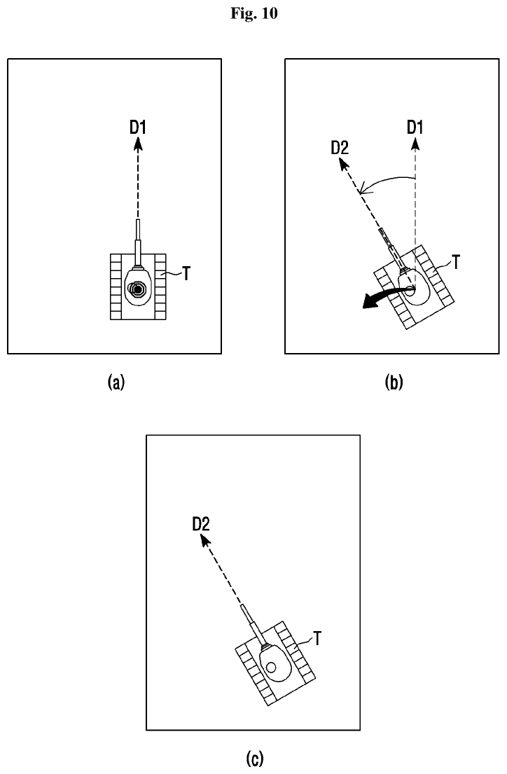

According to the fifth embodiment, when the force and swipe gesture is made on an object displayed on the screen, an operation of changing the rotation or orientation of the object in accordance with the swipe gesture is performed. There may be various objects such as a character or an item in a game, an image, or an object to be edited in an image editing application, etc. When the object is displayed on the screen, the user applies the pressure touch to the object to be manipulated and makes the swipe gesture to rotate the object in a desired direction and then releases his/her hand. Then, the orientation of the object is set as an orientation corresponding to the end point of the swipe gesture. FIG. 10 shows an example in which the pressure touch is, as shown in (a), applied to an object T of the game in the orientation of D1 on the screen and the orientation of the object T is, as shown in (b), changed (or the rotation is controlled) by making the swipe gesture and the touch ends when the orientation is a desired orientation and then the orientation of the object T is, as shown in (c), set as the desired direction of D2. On the other hand, while the swipe gesture is being made, the orientation of the object can be changed and displayed according to the swipe gesture. Alternatively, while the swipe gesture is being made, only a value or arrow indicating the orientation of the object can be changed and displayed.

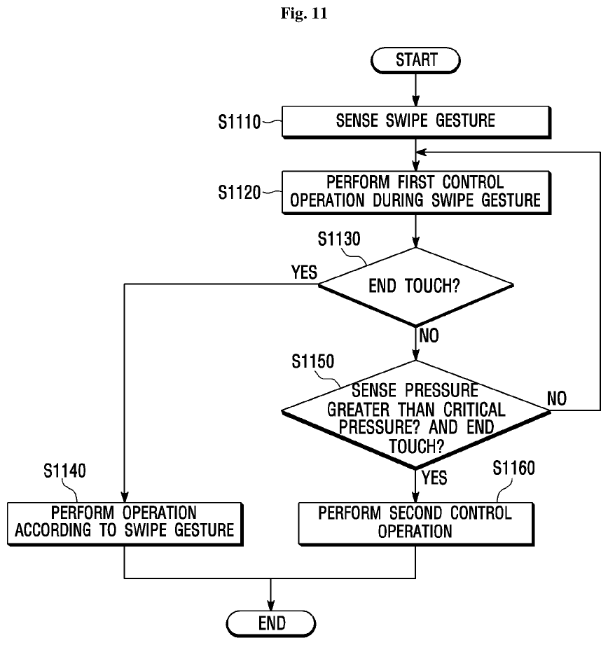

Next, an example of the operation of the device according to the swipe and force gesture will be described with reference to FIG. 11.

When the control unit 180 senses that the swipe gesture starts from the first touch point (step S1110), a first control operation is performed while the swipe gesture is made (step S1120). In some embodiments, step S1120 may be omitted. The first control operation may include that when the swipe gesture is made on an object (for example, a text message in a list, an email, a document file, a music file, a video file, an application, a character in a game, etc.), the corresponding object is displayed along the swipe path. When the touch ends after the swipe gesture (YES in step S1130), the control unit 180 recognizes this as the swipe gesture and performs a predetermined control operation according to the swipe gesture in step S1140. The control operation according to the swipe gesture may be defined for each device and a detailed description thereof is omitted because this does not relate to the present invention.

Meanwhile, after the swipe gesture is sensed, when a pressure greater than a critical pressure is sensed at the second touch point while maintaining the touch and the touch ends (YES in step S1150), the control unit 180 recognizes this as the swipe and force gesture and performs a predetermined control operation (hereinafter, referred to as a second control operation) according to the swipe and force gesture in step S1160.

Meanwhile, according to the embodiment, in step S240, the predetermined control operation can be performed even while the swipe gesture is made. For example, when there is an object such as an icon or a game character at the first touch point, the object may be displayed along the moving path of the swipe gesture.

It is also possible to configure such that when the swipe gesture is sensed in step S1110, the direction of the swipe gesture is determined together. The direction of the swipe gesture may be determined on the basis of the size of the up and down component and the size of the right and left component of an initial swipe direction. For example, if the swipe gesture is, as shown in FIG. 3, made from a touch point P1 to a touch point P2, it is possible to distinguish whether the direction of the swipe gesture is the up and down direction or right and left direction on the basis of the size of the up and down component y and the size of the right and left component x of the swipe direction.

For example, when the touch point moves, as shown in (a) of FIG. 4, to a touch point P4 after the pressure touch is performed, the absolute value of the up and down component y4 of the initial direction is larger than the absolute value of the right and left component x4 and the up and down component y4 has a positive value. Therefore, it is determined that the swipe gesture is in the upward direction. when the touch point moves, as shown in (b) of FIG. 4, to a touch point P5 after the pressure touch is performed, the absolute value of the right and left component x5 is larger than the absolute value of the up and down component y5 and the right and left component x5 has a negative value. Therefore, it is determined that the swipe gesture is in the left direction.

Alternatively, it is possible to configure to distinguish whether the direction of the swipe gesture is the up and down direction or the right and left direction on the basis of the size of the up and down component y and the size of the right and left component x of a vector between the pressure touch point and the swipe end point.

According to the embodiment, it may be configured to perform a specified control operation according to the direction of the swipe gesture. In addition, it is possible to configure to perform a specified control operation when the swipe direction and the time of the swipe gesture satisfy a predetermined condition. Alternatively, it may be configured to perform a specified control operation when the swipe direction and the swipe distance satisfy a predetermined condition. For example, it may be configured to perform an “A” control operation when the pressure touch is performed after swiping upward quickly, and to perform a “B” control operation different from the “A” control operation when the pressure touch is performed after swiping downward quickly.

Also, according to the embodiment, it may be configured to determine that it is a valid swipe and force gesture only when the pressure touch is performed a predetermined number of times while the touch is maintained as it is after the swipe gesture is made. For example, only when the pressure touch is performed twice while the touch is maintained as it is after the swipe gesture is made, it may be determined that it is a valid swipe and force gesture

Next, some embodiments of the control operation according to the swipe and force gesture will be described.

### SIXTH EMBODIMENT

In the sixth embodiment, when the user performs the swipe and force gesture while the application is being run, the running application is terminated. That is, after the swipe gesture from the first touch point to the second touch point sensed while the application is running, the control unit 180 terminates the running application when the pressure touch is performed.

According to the embodiment, the application may be terminated only when the swipe gesture and/or the force touch satisfy a predetermined condition. For example, the application termination operation may be performed when the direction of the swipe gesture satisfies a predetermined condition. For example, the application termination operation may be performed only when the pressure touch is performed after the swipe gesture is made downward.

According to the embodiment, the application termination operation may be performed when the direction of the swipe gesture is a downward direction and the time of the swipe gesture is within a predetermined time. In other words, the running application may be terminated when the pressure touch is performed after swiping downward quickly, the running application may be terminated. It may be configured to terminate the running application when the direction of the swipe gesture is downward and the swipe distance satisfies a predetermined distance condition. For example, the running application may be terminated when the pressure touch is performed after swiping downward shorter than a predetermined distance. In addition, it may be configured to terminate the running application only when two pressure touches are performed at the same position without releasing the hand after the swipe gesture is made.

### SEVENTH EMBODIMENT

In the seventh embodiment, when the swipe and force gesture is made in a state where a keyboard is displayed on the screen, the keyboard is changed into a one-hand input keyboard. According to the embodiment, it is possible to configure to change the keyboard into the one-hand input keyboard only when the swipe and force gesture is made on the keyboard.

In the embodiment, as shown in FIG. 5, displayed, the keyboard is changed into the one-hand input keyboard by the swipe and force gesture. The swipe and force gesture can be made by the thumb of the hand holding the device. Therefore, even when a character or a phone number needs to be input only by one hand, a character can be input by changing the keyboard into the one-hand keyboard.

The one-hand keyboard is generally pushed to any one of the right and left sides. According to the embodiment, the arrangement direction of the one-hand keyboard may be determined based on the swipe direction of the swipe and force gesture. For example, when the swiping is done to the left, the keyboard is, as shown in FIG. 6, displayed to be pushed to the left. Alternatively, it is often more convenient to swipe the thumb in the opposite direction to a direction of the back of the hand than to swipe the thumb toward the back of the hand, so that the keyboard can be displayed on the opposite side to the swipe direction. For example, when the device is held by the left hand, the keyboard arranged on the left side is convenient. In this case, swiping the thumb to the right may be more convenient than swiping to the left. For such a user, when the swiping is done to the right, the keyboard may be, as shown in FIG. 6, configured to be displayed to be pushed to the left. In order to return from the one-hand keyboard mode of FIG. 6 to a typical keyboard mode, the swipe and force gesture is made on the keyboard again, or a bracket portion (>) shown in FIG. 6 is touched.

In addition, according to the embodiment, the arrangement direction of the one-hand keyboard may be determined based on the position of the start point of the swipe gesture, i.e., the first touch point. For example, when the pressure touch is performed on the left side from the center of the keyboard, that is, when the first touch point is left, the one-hand keyboard is displayed to be pushed to the left, and when the first touch point is right, the one-hand keyboard is displayed to be pushed to the right. In this case, the second touch point does not affect the arrangement direction of the one-hand keyboard. According to the embodiment, the arrangement direction of the one-hand keyboard may be determined based on the position of the second touch point rather than the first touch point.

Meanwhile, FIG. 6 shows that a keyboard that has the same form as that of a typical keyboard and is displayed to be pushed to any one side is used as the one-hand keyboard. However, the form of the one-hand keyboard is not limited to a specific form. For example, the keyboard may be configured to have a semicircular form or a quarter circle form shown in FIG. 7 such that it is convenient to input with the thumb of one hand. FIG. 7 shows an example of the one-hand keyboard in a case where key input is performed by the thumb of the right hand.

### EIGHTH EMBODIMENT

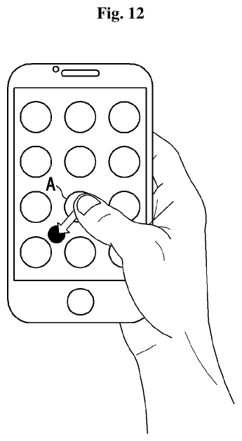

In the eighth embodiment, when the swipe and force gesture is made on an object, a file control operation is performed such as deleting the object, transmitting the object to another place, for example, a recycle bin, or forwarding the object to the outside. There may be various objects such as a text message, an email, a document file, a music file, a video file, an application, a friend list, and the like. When the list of the objects is displayed on the screen, the user makes the swipe gesture after applying the pressure touch to the object to be manipulated. According to the embodiment, an operation to be performed can be designated based on the swipe direction. For example, when the swipe gesture is made downward, the corresponding object may be deleted, and when the swipe gesture is made upward, the operation to transmit to another place may be performed. FIG. 12 is a view showing that an object A is deleted by applying the pressure touch after making the swipe gesture downward by the thumb of a hand holding the device. The transmitting operation to another place may be, for example, transmit to another application, transmit to another device, transmit to (copy in) a temporary storage space, transmit to (stores in) another storage space (contacts, photo album, and the like), etc. In addition, when there are a plurality of transfer destinations, the swipe and force gesture is made, so that a list of transfer destinations (other applications, other devices, storage spaces, etc.) is displayed and one of them is selected.

### NINTH EMBODIMENT

According to the ninth embodiment, when the swipe and force gesture is performed on the object displayed on the screen, the position of the object is changed according to the swipe gesture. There may be a variety of objects such as a file on a file list, a character in a game, an application on an application list, a friend on a friend list, or a digital note (digital Post-it). When the object is displayed on the screen, the user makes the swipe gesture on the object to be manipulated and applies the pressure touch on the object at a destination (second touch point) to which the object is intended to be moved. The object is then moved and placed from its original position (first touch point) to the second touch point. Meanwhile, it is also possible to configure to display the object along the moving path of the swipe gesture while the swipe gesture is being made. For example, the user may take notes on the digital note in the smartphone, moves the position of the digital note to a desired position of the swipe gesture, and then applies the pressure touch, so that the digital note is attached like Post-it.

### TENTH EMBODIMENT

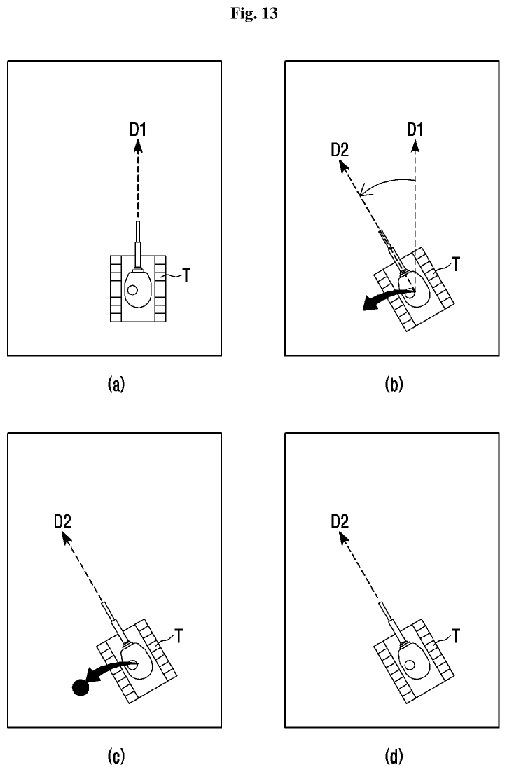

According to the tenth embodiment, when the swipe and force gesture is made on an object displayed on the screen, an operation of changing the rotation or orientation of the object in accordance with the swipe gesture is performed. There may be various objects such as a character or an item in a game, an image, or an object to be edited in an image editing application, etc. When the object is displayed on the screen, the user makes the swipe gesture on the object to be manipulated, rotates the object in a desired direction, and then applies the pressure touch. Then, the orientation of the object is set as an orientation corresponding to the point where the pressure touch has been applied. FIG. 13 shows an example in which the orientation of an object T of the game screen, which faces in the orientation of D1, is changed (or the rotation is controlled) by making, as shown in (b), the swipe gesture on the object T and the pressure touch is, as shown in (c), performed when the orientation is a desired orientation and then the orientation of the object T is as shown in (d), set as the desired direction of D2. On the other hand, while the swipe gesture is being made, the orientation of the object can be changed and displayed according to the swipe gesture. Alternatively, while the swipe gesture is being made, only a value or arrow indicating the orientation of the object can be changed and displayed.

### ELEVENTH EMBODIMENT

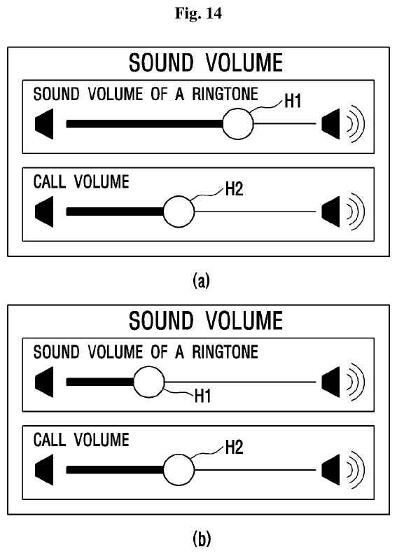

In the eleventh embodiment, when a handle capable of changing screen brightness, sound volume, reproduction speed, zoom level, etc., (hereinafter, referred to as “control amount”) is displayed on the screen, a value of the control amount is controlled according to the swipe gesture starting from a position (first touch point) where the handle is displayed, and when the pressure touch is applied the second touch point, a value of the control amount corresponding to the second touch point is set as a default value of the control amount. For example, as shown in (a) of FIG. 14, in the screen showing a handle H1 for adjusting the sound volume of a ringtone and a handle H2 for adjusting the call volume, when the swipe gesture is performed after touching the handle H1 and the pressure touch is, as shown in FIG. 14 (b) without releasing the hand, a default value of the sound volume of the ringtone is set as a volume size corresponding to the pressure touch point. On the other hand, in (a) of FIG. 14, by touching the handle (H1) and making the swipe gesture, the volume sound of the ringtone can be adjusted in (b) of FIG. 14 even if the hand is released without the pressure touch. However, this means that the volume sound of the ringtone is temporarily set as a volume size corresponding to the position of the handle H1 shown in (b) and is not set as a default value. That is, by touching the handle H1 and making the swipe gesture, and then by applying the pressure touch and releasing the hand, the default value is set. If the hand is released without applying the pressure touch, the default value is not set. When the default value is set, even if the user adjusts in the middle the sound volume and then turns the device off and on, the volume sound of the ringtone is set as the default value, not the final sound volume.

### TWELFTH EMBODIMENT

In the twelfth embodiment, in a swipe sensing step, when the object is touched during the swiping, information related to the object is displayed, and when the pressure touch is performed on the object, control operations related to the object are performed. An example of the information related to the object may include a description of the object, a preview of the object of an image/video, and a profile (description) or a picture (preview) of the object that is a person, and the price of the object that is an article or service, etc.

In some embodiments, when the object is touched during the swiping, the object may be highlighted. The object may be highlighted by using various methods such as enlarging the object, changing the color of the object, for example, inverting the color of the object, changing the color of the object to another one, or displaying the object in black and white, or changing the brightness or saturation of the object, changing the shape, pattern, background, etc., of the object, displaying the object blinking or moving, or displaying the object consisting of text in bold type, etc. As such, when the user applies the pressure touch while the object is displayed with highlight, control operations related to the highlighted object are performed.

The control operation related to the object may include, for example, purchasing or renting the object to be purchased or rented, executing of the executable object (for example, if the object is an image, an image editing program is executed, and if the object is a document, a document editing program is executed), writing an email to, making a call to, and writing a text message to the object that is a person, deleting the object from the list, setting a group, or selecting the object, etc.

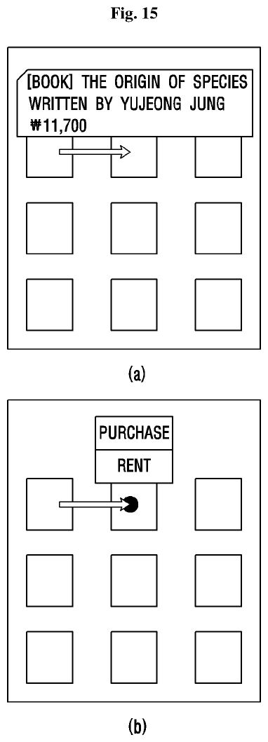

In FIG. 15, in the state where icons such as movies, books, etc., are displayed on the screen, when the user makes the swipe gesture and touches the object (icon) during the swiping, information (the title of the book, the writer of the book, the price of the book) related to the object is, as shown in (a), displayed. In this state, when the pressure touch is applied, a menu for purchasing or renting the books corresponding to the touched object appears so that the user can purchase or rent the books.

The features, structures and effects and the like described in the embodiments are included in one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

### INDUSTRIAL APPLICABILITY

According to the embodiment of the present invention, since it is possible to easily terminate running applications by using one finger even without using a separate home button, it is convenient to use the device according to the embodiment of the present invention. Also, since it is not necessary to press the home button for the termination of the application, the home button can be removed according to the design of the device.

According to another embodiment of the present invention, it is possible to easily change with one hand to a one-hand keyboard mode which allows a key input to be performed with one hand.

According to further another embodiment of the present invention, operations such as deletion, transmission, movement, rotation, and information display of the object, etc., can be easily performed with one hand.

According to yet another embodiment of the present invention, the setting of a default value of a control amount such as screen brightness, sound volume, reproduction speed, zoom level, etc., can be simply controlled with one hand.

1. A control method in a device capable of sensing a touch and touch pressure, the control method comprising:
a pressure touch sensing step of sensing a pressure touch at a first touch point;
a swipe sensing step of sensing a swipe gesture in which the touch point is moved subsequent to the pressure touch; and
a control operation step of performing a control operation when the swipe gesture ends.

2. The control method of claim 1, wherein, when the pressure touch sensing step and the swipe sensing step are performed in a state where an application is being run, the control operation terminates the running application.

3. The control method of claim 1, wherein the control operation is for changing to a one-hand keyboard mode.

4. The control method of claim 3, wherein the operation for changing to a one-hand keyboard mode is performed when the pressure touch and the swipe gesture are performed on a keyboard.

5. The control method of claim 4, wherein, when a direction of the swipe gesture is left, the one-hand keyboard is displayed to be pushed to the left, and when the direction of the swipe gesture is right, the one-hand keyboard is displayed to be pushed to the right.

6. The control method of claim 4, wherein, when a direction of the swipe gesture is left, the one-hand keyboard is displayed to be pushed to the right, and when the direction of the swipe gesture is right, the one-hand keyboard is displayed to be pushed to the left.

7. The control method of claim 4, wherein, when a position of the pressure touch is left, the one-hand keyboard is displayed to be pushed to the left, and when the position of the pressure touch is right, the one-hand keyboard is displayed to be pushed to the right.

8. The control method of claim 1, wherein, when the pressure touch and the swipe gesture are performed on an object, the control operation controls at least one of deletion and transmission of the object.

9. The control method of claim 8, wherein, when a direction of the swipe gesture is downward, the object is deleted, and when the direction of the swipe gesture is upward, the object is transmitted.

10. The control method of claim 1, wherein, when the pressure touch is performed on an object, the control operation controls a position of the object in accordance with the swipe gesture.

11. The control method of claim 10, wherein the control operation moves the object to an end point of the swipe gesture.

12. The control method of claim 11, wherein, in the swipe sensing step, the object is displayed along a moving path of the swipe gesture while the swipe gesture is being made.

13. The control method of claim 11, wherein the object is any one of a file on a file list, a character in a game, an application on an application list, and a friend on a friend list.

14. The control method of claim 1, wherein, when the pressure touch is performed on an object, the control operation controls a rotation of the object in accordance with the swipe gesture.

15. The control method of claim 1, wherein the control operation step is performed when a direction of the swipe gesture satisfies a predetermined condition.

16. The control method of claim 1, wherein the control operation step is performed when a time period during which the swipe gesture is made is within a predetermined time.

17. The control method of claim 1, wherein the control operation step is performed when a swipe distance satisfies a predetermined condition.

18. The control method of claim 1, wherein the control operation step is performed when the pressure touch is sensed a predetermined number of times before the swipe gesture is made.

19. The control method of claim 1, wherein a critical pressure is settable by a user.

20. A control method in a device capable of sensing a touch and touch pressure, the control method comprising:
a swipe sensing step of sensing a swipe gesture in which a touch point is moved from a first touch point to a second touch point;
a pressure touch sensing step of sensing a pressure touch at a second touch point subsequent to the swipe gesture; and
a control operation step of performing a control operation when the pressure touch is sensed.

21. The control method of claim 20, wherein, when the pressure touch sensing step and the swipe sensing step are performed in a state where an application is being run, the control operation terminates the running application.

22. The control method of claim 20, wherein the control operation is for changing to a one-hand keyboard mode.

23. The control method of claim 22, wherein the operation for changing to a one-hand keyboard mode is performed when the first touch point and the second touch point are on the keyboard.

24. The control method of claim 23, wherein, when a direction of the swipe gesture is left, the one-hand keyboard is displayed to be pushed to the left, and when the direction of the swipe gesture is right, the one-hand keyboard is displayed to be pushed to the right.

25. The control method of claim 23, wherein, when a direction of the swipe gesture is left, the one-hand keyboard is displayed to be pushed to the right, and when the direction of the swipe gesture is right, the one-hand keyboard is displayed to be pushed to the left.

26. The control method of claim 23, wherein, when a position of the first touch point is left, the one-hand keyboard is displayed to be pushed to the left, and when the position of the first touch point is right, the one-hand keyboard is displayed to be pushed to the right.

27. The control method of claim 20, wherein, when an object is positioned at the first touch point, the control operation controls at least one of deletion and transmission of the object.

28. The control method of claim 27, wherein, when a direction of the swipe gesture is downward, the object is deleted, and when the direction of the swipe gesture is upward, the object is transmitted.

29. The control method of claim 20, wherein, when an object is positioned at the first touch point, the control operation controls a position of the object.

30. The control method of claim 29, wherein the control operation moves the object to the second touch point.

31. The control method of claim 30, wherein, in the swipe sensing step, the object is displayed along a moving path of the swipe gesture while the swipe gesture is being made.

32. The control method of claim 30, wherein the object is any one of a file on a file list, a character in a game, an application on an application list, and a friend on a friend list.

33. The control method of claim 20, wherein, when an object is positioned at the first touch point, the control operation controls an orientation of the object in accordance with the swipe gesture and fixes the orientation of the object in a direction corresponding to the second touch point.

34. The control method of claim 20, wherein the control operation controls any one of screen brightness, sound volume, reproduction speed, and zoom level (hereinafter, referred to as “control amount”), controls a value of the control amount in accordance with the swipe gesture, and sets a value of the control amount corresponding to the second touch point as a default value of the control amount.

35. The control method of claim 20, wherein, in the swipe sensing step, when an object is touched during the swiping, information related to the object is displayed, and wherein, when the pressure touch is performed on the object, control operations related to the object are performed.

36. The control method of claim 35, wherein the information related to the object comprises one or more of a preview of the object, a description of the object, and a sale price of the object.

37. The control method of claim 20, wherein, in the swipe sensing step, when an object is touched during the swiping, the object is highlighted, and wherein, when the pressure touch is performed on the object, control operations related to the object are performed.

38. The control method of claim 20, wherein the control operation step is performed when a direction of the swipe gesture satisfies a predetermined condition.

39. The control method of claim 20, wherein the control operation step is performed when a time period during which the swipe gesture is made is within a predetermined time.

40. The control method of claim 20, wherein the control operation step is performed when a swipe distance satisfies a predetermined condition.

41. The control method of claim 20, wherein the control operation step is performed when the pressure touch is sensed a predetermined number of times.

42. The control method of claim 20, wherein a critical pressure is settable by a user.

43. A device comprising:
a display;
a touch sensing unit which senses a touch at a particular position;
a pressure sensing unit capable of sensing a magnitude of a pressure at the touched position; and
a control unit which controls an operation of the device in accordance with an input of a user through the touch sensing unit and the pressure sensing unit, and performs the control operation when a pressure touch is sensed and a swipe gesture in which the touch point is moved is sensed and then the swipe gesture ends.

44. The device of claim 43, wherein the control operation is one of termination of running applications, changing into a one-hand keyboard mode, deletion or transmission of an object, movement of the object, and rotation control of the object.

45. A device comprising:
a display;
a touch sensing unit which senses a touch at a particular position;
a pressure sensing unit capable of sensing a magnitude of a pressure at the touched position; and
a control unit which controls an operation of the device in accordance with an input of a user through the touch sensing unit and the pressure sensing unit, and performs the control operation when a pressure touch is sensed at a second touch point subsequent to a swipe gesture in which a touch point is moved from a first touch point to the second touch point.

46. The device of claim 45, wherein the control operation is one of termination of running applications, changing into a one-hand keyboard mode, deletion or transmission of an object, movement of the object, and setting of a default value of a control amount.
